(19) United States
(12) Patent Application Publication
(10) Pub. No.: US 2011/0084979 A1
(43) Pub. Date: Apr. 14, 2011

(54) INTEGRATED ELECTRONIC PAPER DISPLAY CONTROLLER

(75) Inventors: Serge RUTMAN, Boulder Creek, CA (US); Samson HUANG, Saratoga, CA (US); Tarik ISANI, New York, NY (US)

(73) Assignee: FIRSTPAPER LLC, New York, NY (US)

(21) Appl. No.: 12/576,297

(22) Filed: Oct. 9, 2009

(51) Int. Cl. G09G 5/02; G09G 3/34

(52) U.S. Cl. 345/589; 345/694; 345/107

(57) ABSTRACT

A system for and method of controlling an electronic display, such as an electrophoretic display, using an integrated electronic paper display controller are disclosed. The system and method provide for transparent translation of standard image data into signals sufficient to drive such displays and implement the corresponding image.

### FIELD OF THE INVENTION

The present invention generally relates to a system for and method of controlling an electronic paper display using an integrated electronic paper display controller.

### BACKGROUND INFORMATION

In general, some controller devices that are configured to control the operations of an electronic paper display may use a substantial amount of circuit board space. These controller devices may also operate inefficiently by failing to implement certain power saving techniques. Accordingly, improvements to controller devices that are configured to operate electronic paper displays may be desired.

### BRIEF DESCRIPTION OF THE DRAWINGS

The present invention, together with further objects and advantages, may best be understood by reference to the following description taken in conjunction with the accompanying drawings, in the several figures of which like reference numerals identify like elements, and in which:

FIG. 1 is a schematic diagram of an electronic paper display (“EPD”) controller system according to an embodiment of the present invention;

FIG. 2 is a schematic diagram of an EPD controller block coupled to two data buses according to an embodiment of the present invention;

FIG. 3 is a schematic diagram of an EPD controller block according to an embodiment of the present invention;

FIG. 4 is a schematic diagram that illustrates frame buffer caching according to an embodiment of the present invention;

FIG. 5 is a flow chart illustrating a parallel pixel update according to an embodiment of the present invention;

FIG. 6 is a pixel pipeline diagram illustrating a parallel pixel update according to an embodiment of the present invention;

FIG. 7 is a schematic diagram of a pixel look up table (“LUT”) and a shift register according to an embodiment of the present invention;

FIG. 8 is a logic diagram of sleep mode request logic according to an embodiment of the present invention;

FIG. 9 is a schematic diagram illustrating source driver connections according to an embodiment of the present invention; and

FIG. 10 is a schematic diagram illustrating gate driver connections according to an embodiment of the present invention.

### SUMMARY OF EMBODIMENTS OF THE INVENTION

At least one exemplary embodiment may provide a hardware implemented method for partially updating an electrophoretic display using an electrophoretic display controller block and a central processing unit that are integrated into a system on a chip. This embodiment may include scanning a complete set of new pixel values in an electronic memory, comparing, during the scanning and using logical circuitry, the new pixel values to existing pixel values, determining, during the scanning and based on the comparing, a set of pixels whose values have changed, and initiating an update sequence for each pixel in the set of pixels whose values have changed, wherein the initiating occurs during the scanning, and wherein at least one update sequence comprises delivering a series of voltage potentials.

Another exemplary embodiment according to this invention may provide a hardware implemented method for updating an electrophoretic display in parallel using an electrophoretic display controller block and a central processing unit that are integrated into a system on a chip. This embodiment may include providing an electronic memory storing a current pixel value for each pixel in the electrophoretic display, providing an electronic memory storing a new pixel value for each pixel in the electrophoretic display, providing a hardware implemented step counter for each pixel in the electrophoretic display, identifying a changed pixel, wherein a current pixel value for the changed pixel is different from a new pixel value for the changed pixel, determining, for the changed pixel, whether a step counter associated with the changed pixel indicates that the pixel is transitioning to a new pixel value, retrieving from an electronic memory a signal value associated with the current pixel value for the changed pixel, the new pixel value for the changed pixel and a step counter value for the changed pixel, providing the signal value to a portion of the electrophoretic display corresponding to the changed pixel, and updating the step counter value associated with the changed pixel.

Another exemplary embodiment according to this invention may provide a system for controlling an electrophoretic display using an electrophoretic display controller block and a central processing unit that are integrated into a system on a chip. This embodiment may include a computing apparatus configured to store an existing frame, wherein the existing frame comprises a plurality of existing lines, wherein each existing line comprises a set of existing pixel values, a computing apparatus configured to receive a new frame and store the new frame in an electronic memory, wherein the new frame comprises a plurality of new lines, wherein each new line comprises a set of new pixel values, a computing apparatus configured to compare each existing pixel value to a corresponding new pixel value to determine a set of pixels whose values have changed, and a computing apparatus configured to deliver a series of voltage potentials to a portion of the electrophoretic display corresponding to a changed pixel.

### DETAILED DESCRIPTION OF EMBODIMENTS OF THE INVENTION

Certain embodiments of the present invention provide a controller for a display. More particularly, certain embodiments of the present invention provide a system for and method of controlling electronic paper displays (referred to herein as “EPD”), such as electrophoretic displays or electro-wetting displays, using an integrated EPD controller. Examples of such displays include those disclosed in U.S. Pat. Nos. 6,577,433, 6,529,313, 6,525,866, 6,574,034, 6,017,584, 6,067,185, 6,118,426, 6,120,839, 6,124,851, 6,130,774, 6,172,798, 6,177,921, 6,232,950 and 6,249,271. An EPD may include one based on technology from the E Ink Corporation of Cambridge, Mass. or any other supplier of an EPD.

EPD generally present engineering issues that are absent from, for example, cathode ray tube (“CRT”) displays. One example has to do with how EPD use electrostatic forces to create images. A single EPD may utilize positive, negative and neutral voltages to affect image depictions and image changes. More particularly, each EPD pixel may receive (at different times) positive, negative or neutral voltages, which, in combination, select the color or shade of gray embodied in such pixel. The use of both positive and negative voltages generally implicates the use of a controller that can translate image data (e.g., in the form of data on a system data bus) into signals sufficient to affect the display of the corresponding image on an EPD. Certain embodiments of the present invention therefore provide a controller that can translate image data received from a host system into signals (e.g., sequences of targeted positive and negative voltages) that may be applied to an EPD to display and change images.

Another engineering issue example arises due to EPD response times. EPD generally respond to image changes slower than, for example, CRT displays. This may arise because some EPD require transitioning between intermediate states in order to change from displaying one image to another. This relative slowness presents engineering challenges in displaying video or real-time user interface features such as mouse pointers and cursors. As yet another example, EPD are persistent (i.e., state bistable) in that they retain their displayed image in the absence of power. The persistence of EPD images creates engineering issues that are not present in, for example, CRT displays. As yet another example, EPD may require temperature monitoring and corresponding adjustment of input parameters. These and other engineering challenges create a need for a controller that can meet the unique needs of an EPD.

Certain embodiments of the present invention may provide a highly integrated EPD controller system. The EPD controller system may include a host central processing unit and a EPD controller block (e.g., an Intellectual Property (IP) block) that are integrated into a system on chip (“SoC”). The host central processing unit may include a set of one or more instructions that are executed to operate one or more main functions of a host device (e.g., the SoC). The EPD controller block may include a set of one or more instructions that are executed to control the display of images on an EPD. In one embodiment, the host central processing unit and the EPD controller block of the EPD controller system may be configured to operate as a shared memory architecture. That is, the host central processing unit and the EPD controller block may be designed to access and share the same memory block (e.g., the system memory).

The amount of system memory that is allocated (e.g., partitioned) to the host central processing unit and the EPD controller block may be fixed in a shared memory architecture. For example, a host device that has a system memory that stores up to 512 Mega Bytes (MB) of data may allocate 448 MB portion of the system memory to the host central processing unit and 64 MB portion of the system memory to the EPD controller block. Alternatively, the entire system memory may be accessible and shared (as a single pool of memory) by the host central processing unit and the EPD controller block. In this embodiment, portions of the system memory may be allocated to the host central processing unit and the EPD controller block when demand arises (e.g., on-the-fly) using one or more pointers (e.g., a pointer that references the address of the frame buffer section of the system memory that stores current pixel data, a pointer that references the address of one or more working registers that store new pixel data and old pixel data). Such an embodiment may include a Unified Memory Architecture (UMA).

The host central processing unit and the EPD controller block of the EPD controller system may be configured to operate as a UMA. Operating as a UMA may provide the EPD controller system with certain advantages. For example, the UMA may decrease the cost of manufacturing an EPD controller system. Since, in a UMA, the EPD controller block is configured to share the system memory with the host central processing unit, the need for an external memory source (e.g., a frame buffer that stores image data that corresponds to display pixels) that is dedicated to the EPD controller block may be eliminated. Accordingly, an EPD controller system that is configured to operate as a UMA may decrease the cost of manufacturing the EPD controller system by at least the amount necessary to procure the external frame buffer.

In another example, the UMA may decrease the amount of power consumed by an EPD controller system. Since, in a UMA, the EPD controller block is configured to share the system memory with the host central processing unit, the need to copy the image data that is received by the host central processing unit to an external frame buffer that is dedicated to the EPD controller block may be eliminated. Accordingly, an EPD controller system that is configured to operate as a UMA may decrease the amount of power consumed by the EPD controller system by at least the amount of power resources that would be used to copy image data to the external frame buffer.

In yet another example, the UMA may decrease the amount of printed circuit board (PCB) space used to manufacturer an EPD controller system. Since, in a UMA, the EPD controller block is configured to share the system memory with the host central processing unit, the need for an external frame buffer that is dedicated to the EPD controller block may be eliminated. Accordingly, an EPD controller system that is configured to operate as a UMA may decrease the amount of PCB space that is needed to manufacture the EPD controller system by at least the amount of PCB space that would be used by the external frame buffer.

The EPD controller system may employ an Advanced Microcontroller Bus Architecture (AMBA) that was produced by the ARM Holdings company of Cambridge, England, United Kingdom (UK) to ensure that the host central processing unit and the EPD controller block maintain sufficient access to data. For example, an Advanced Extensible Interface (AXI) and an Advanced High-performance Bus (AHB) of the AMBA may be used in the EPD controller system to control data flow. Use of the AMBA may assist the EPD controller system to be easily integrated into other ARM-based platforms.

The EPD controller system may support the programmability of one or more clocks. For example, the frequency of one or more clocks of the host central processing unit may be programmed. In another example, the frequency of one or more clocks of a memory interface (e.g., a Double Data Rate (DDR) memory interface) may be programmed. In yet another example, the frequency of one or more clocks of the EPD may be programmed. Accordingly, a user of the EPD controller system may program the frequency of one or more clocks of the EPD controller system maximize performance and minimize power consumption.

The EPD controller system may support the rendering of one or more images on the EPD in one or more image resolutions. In one embodiment, the EPD may be configured to render an image in a low image resolution (e.g., SVGA 600×800) to reduce power consumption. In such an embodiment, the image quality of one or more images displayed on the EPD as perceived by a user of the EPD controller system may be decreased. In another embodiment, the EPD may be configured to render an image in a high image resolution (e.g., UXGA 1200×1600). In such an embodiment, the image quality of one or more images displayed on the EPD as perceived by a user of the EPD controller system may be increased.

The EPD controller system may be configured to render portions of images on the EPD in varying image resolutions. By way of a non-limiting example, an image may be divided into three portions. The EPD controller system may be configured to render a first portion of the image on the EPD in a low image resolution. The EPD controller system may be configured to render a second portion of the image on the EPD in a medium image resolution. The EPD controller system may be configured to render a third portion of the image on the EPD in a high image resolution. In such embodiments, the image resolutions of an image may be determined by one or more factors, such as input from user, type of image content in a portion (e.g., text, picture), need for power resources, need for a particular display quality, etc.

The EPD controller system may be configured to perform full flash updates of an image, partial updates of an image, parallel updates of an image, or any other update sequence that updates the pixel data of one or more pixels. A full flash update of an image on the EPD may include the update of the pixel data for all pixels. The partial update of an image on the EPD may include the update of the pixel data of only the pixels that are associated with pixel values that have changed between a current image and a new image. The parallel update of an image on the EPD may include the update of the pixel data of one or more pixels that are associated with a pixel value that has changed in the frame buffer without waiting for the update of other pixels.

In one embodiment, the EPD controller system may also be configured to utilize certain power saving techniques that reduce the amount of time the EPD controller block and the EPD operate in power consuming states.

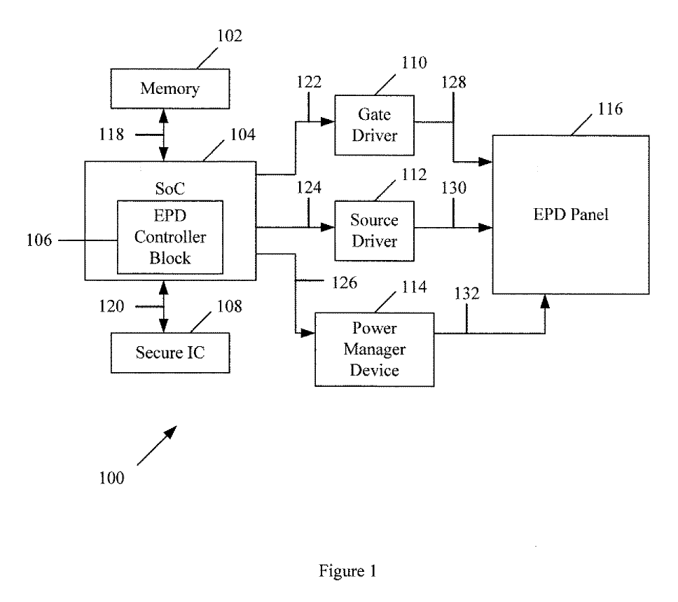

FIG. 1 is a schematic diagram of an EPD controller system 100 according to an embodiment of the present invention. The EPD controller system 100 may be used in an electronic device, such as an electronic book, an electronic newspaper, and a personal media device to receive and display image data corresponding to one or more images in the form of pixel data. Once received, the EPD controller system 100 may translate the image data into pixel data that is used to generate a series of one or more signals sufficient to affect the display of the corresponding image data on the EPD panel 116.

The EPD controller system 100 may include any, or a combination, of one or more memories 102, one or more EPD controller blocks 106 integrated into one or more system on chips (“SoC”) 104, one or more secure integrated circuits (“IC”) 108, one or more gate drivers 110, one or more source drivers 112, one or more power manager devices 114, and one or more EPD panels 116. One or more components of the EPD controller system 100 may be communicatively coupled to each other using one or more data paths, such as data paths 118, 120, 122, 124, 126, 128, 130, and 132.

Memory 102 may be communicatively coupled to the SoC 104 and the EPD controller block 106 via a bidirectional data path, such as data path 118. In one embodiment, EPD controller block 106 may be coupled to memory 102 via a memory interface, such as a Double Data Rate (DDR-1) SDRAM interface. Memory 102 may include software, hardware, or a combination of both that is configured to receive and store pixel data. For example, memory 102 may include a frame buffer that is configured to store old pixel data, current pixel data, and new pixel data. In one embodiment, memory 102 may include a random access memory integrated circuit, such as a SDRAM integrated circuit. Memory 102 may transmit old pixel data, current pixel data, and new pixel data to the SoC 104 and the EPD controller block 106 via bidirectional data path 118. Memory 102 is discussed in further detail below.

Secure IC 108 may be communicatively coupled to the SoC 104 and the EPD controller block 106 via a bidirectional data path, such as data path 120. Secure IC 108 may include software, hardware, or a combination of both that is configured to provide content security. The secure IC 108 may be configured to provide content security by enabling an interrupt signal that interrupts the operation of the EPD controller block 106 upon determining that at least some of the stored pixel data has been compromised. In one embodiment, secure IC 108 may include a content security IC, such as a content security IC provided by NDS Group Ltd. of Staines, UK. In another embodiment, secure IC 108 may be configured to authenticate one or more users of the EPD controller system 100. In another embodiment, secure IC 108 may be configured to provide security to prevent hacking during one or more boot up sequences.

Gate driver 110 may be communicatively coupled to the SoC 104 and the EPD controller block 106 via a unidirectional data path, such as data path 122 such that input data flows from the SoC 104 and the EPD controller block 106 to the gate driver 110. Gate driver 110 may include software, hardware, or a combination of both that is configured to provide gate driver data to the EPD panel 116 that selects a particular row of display elements to receive source driver data from the source driver 112 based on one or more input signals from the EPD controller block 106. A row of display elements may include a row electrode that is coupled to the gates of one or more of thin-film transistors (“TFT”) that are arranged in a row. The gate driver 110 may provide the gate driver data to the EPD panel 116 via a unidirectional data path, such as data path 128 such that the gate driver data flows from the gate driver 110 to the EPD panel 116. Gate driver 110 is discussed in further detail below.

Source driver 112 may be communicatively coupled to the SoC 104 and the EPD controller block 106 via a unidirectional data path, such as data path 124 such that input data Rows from the SoC 104 and the EPD controller block 106 to the source driver 112. Source driver 112 may include software, hardware, or a combination of both that is configured to provide source driver data (e.g., a series of voltage potentials) to the particular row of display elements selected by the gate driver 110 via one or more column electrodes and one or more TFTs of the EPD panel 116 based on one or more input signals from the EPD controller block 106. The source driver 112 may provide the source driver data to the EPD panel 116 via a unidirectional data path, such as data path 130 such that the source driver data flows from the source driver 112 to the EPD panel 116. Source driver 112 is discussed in further detail below.

Power manager device 114 may be communicatively coupled to the SoC 104 and the EPD controller block 106 via a unidirectional data path, such as data path 126 such that input data flows from the SoC 104 and the EPD controller block 106 to the power manager device 114. Power manager device 114 may include software, hardware, or a combination of both that is configured to manage the flow of power to the EPD panel 116. The power manager device 114 may manage the flow of power to the EPD panel 116 by providing power management data that causes the EPD panel 114 to operate in one or more power saving modes based on one or more input signals from the EPD controller block 106. The one or more power saving modes may include a display active-on mode, a standby-on mode, and a sleep mode. The power manager device 114 may provide the power management data to the EPD panel 116 via a unidirectional data path, such as data path 132 such that the power management data flows from the power manager device 114 to the EPD panel 116.

EPD panel 116 may be communicatively to the gate driver 110, the source driver 112, and the power manager device 114 via unidirectional data path 128, 130, 132, respectively. Accordingly, EPD panel 116 may receive gate driver data from gate driver 110 via data path 128, source driver data from source driver 112 via data path 130, and power management data from power manager device 114 via data path 132. EPD panel 116 may include a plurality of electrodes that are arranged in rows and columns. The intersection of a row and column may include a display element that comprises a pixel. As previously described, each row electrode may be coupled to the gates of one or more of thin-film transistors (“TFT”) that are arranged in a row. Each column electrode may be coupled to the sources of one or more TFTs that are arranged in a column. The EPD panel 116 may operate by selecting a row as indicated by the gate driver data from the gate driver 110 and subsequently providing source driver data to the pixels of the selected row via one or more column electrodes.

EPD controller block 106 may be integrated into SoC 104 and communicatively coupled to the memory 102, gate driver 110, source driver 112, power manager device 114, and secure IC 108 via data paths 118, 122, 124, 126, and 120. EPD controller block 106 may include software, hardware, or a combination of both configured to control the display of pixel data on the EPD panel 116 by transmitting one or more control signals (e.g., input signals) to the memory 102, gate driver 110, source driver 112, power manager device 114, and secure IC 108. EPD controller block 106 is discussed in further detail below.

SoC 104 may include the EPD controller block 106 and a host central processing unit. SoC 104 may be communicatively coupled to the memory 102, gate driver 110, source driver 112, power manager device 114, and secure IC 108 via data paths 118, 122, 124, 126, and 120. In one embodiment, SoC 104 is an exemplary system on chip, such as a system on chip manufactured by Marvell Semiconductor, Inc. of Santa Clara, Calif., such as the SoC advertised as the Aspen 168.

One or more data paths disclosed herein may include any device that communicatively couples one or more devices to each other. For example, one or more data paths may include one or more networks, one or more conductive wires (e.g., copper wires), or one or more data buses.

It should be noted that EPD controller system 100 may be configured to perform one or more functions or features of one or more other controller devices, such as one or more functions or features described in U.S. patent application Ser. No. 12/497,199 entitled “Electronic Display Controller,” filed Jul. 2, 2009, the contents of which are hereby incorporated by reference.

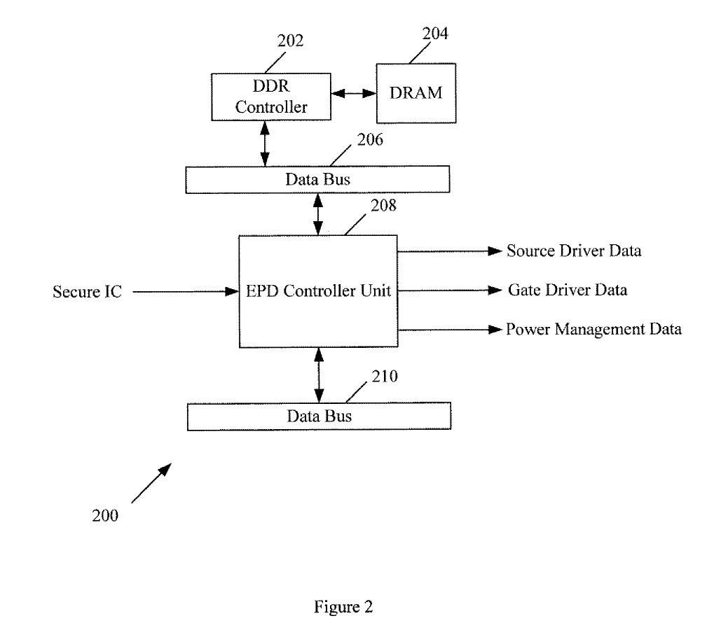

FIG. 2 is a schematic diagram of an EPD controller block 208 coupled to two data buses according to an embodiment of the present invention. EPD controller block 208 may be communicatively coupled to data bus 206 and data bus 210.

Data bus 206 may be communicatively coupled to a memory interface, such as a DDR controller 202 that is communicatively coupled to an electronic memory, such as DRAM 204. Data bus 206 may be configured to transmit pixel data and step counter data to and from the EPD controller block 208.

Data bus 206 access and DDR controller 202 access (and DRAM 204 access) may be shared between the EPD controller block 208 and one or more modules (e.g., software modules) operating in the host central processing unit. To ensure that the EPD controller block 208 maintains access to sufficient memory bandwidth, the EPD controller block 208 may be allotted a high priority relative to the one or more other modules during data bus 206 arbitration and DDR controller 202 arbitration. In one embodiment, the EPD controller block 208 may use a data bus master to interface with data bus 206, such as a 64-bit wide data bus master.

Data bus 210 may be configured to transmit data between the EPD controller block 208 and one or more working registers accessible by the EPD controller block 208. Data bus 210 may be communicatively coupled to an LUT interface such that LUT update data is transmitted to one or more LUTs via data bus 210. In one embodiment, EPD controller block 208 may use a data bus slave to interface with data bus 210, such as a 32-bit wide data bus slave.

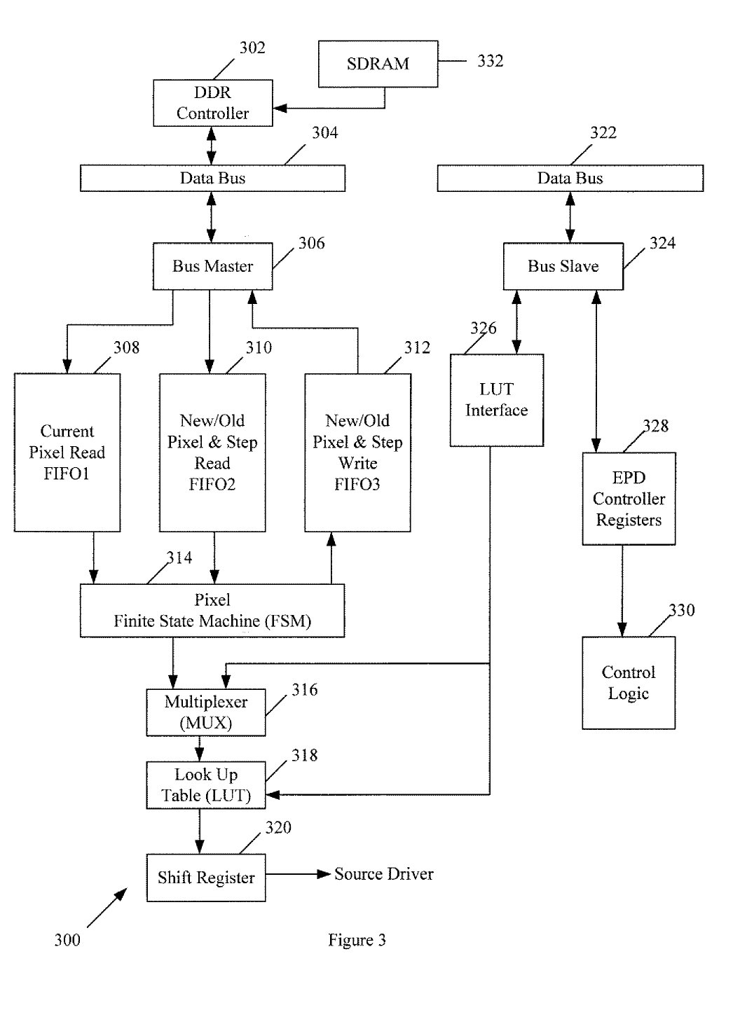

FIG. 3 is a schematic diagram of an EPD controller block 300 according to an embodiment of the present invention. As previously discussed, EPD controller block 300 may be integrated in, by way of non-limiting example, a SoC, such as SoC 104. The embodiment illustrated in FIG. 3 may be installed in an electronic device, such as an electronic book, an electronic newspaper, a personal media device, or any other device that includes or directs an EPD.

EPD controller block 300 is coupled to data bus 304 and to data bus 322. In general, EPD controller block 300 receives image data from a host central processing unit in the frame buffer portion of memory 332 and produces an output, which drives the EPD. EPD controller block 300 thus includes a data bus master 306 that interfaces with data bus 304 to access pixel data stored in memory 332. By way of non-limiting example, data bus 304 may be a system data bus that is configured to transfer pixel data.

EPD controller block 300 also includes a pixel look-up table (“LUT”) 318. In general, transitioning from one image displayed on an EPD to another image displayed on an EPD (e.g., when turning a page in an electronic book) involves multiple steps. That is, changing from one image to another may involve a series of transitional images. Note that the transitional images may be too fleeting to be visible to the naked eye. Herein, an image displayed on an EPD is referred to as a “frame.” Thus, changing from one frame to another may involve multiple steps, each of which may be invisible to the observer. More particularly, changing a single pixel in a frame may involve multiple steps. With each step, EPD controller block 300 causes a signal, corresponding to a transitional pixel state, to be sent to an EPD. The signal may be a positive, negative or zero voltage. Thus, EPD controller block 300 may produce a two-bit output, where three of the four possible two-bit states correspond to positive, negative or zero voltages. By way of non-limiting example, two-bit outputs of “00” or “11” may both map to a zero volt output signal (0V), a two-bit output of “01” may map to a positive fifteen volt output signal (+15V), and a two-bit output of “10” may map to a negative fifteen volt output signal (−15V). Thus, each two-bit output causes the pixel at issue to transition to one or more different intermediate states, until the pixel reaches a final state, concluding the frame change. The collection of steps that change one displayed pixel to another are referred to herein as a “waveform.” It should be noted that a waveform may also describe a series of voltage potentials or stored data representing the series of voltage potentials. It should be noted that the EPD controller block 300 may produce outputs with a plurality of bit sizes, such as two-bit outputs, three-bit outputs, four-bit outputs, five-bit outputs, etc.

As described in greater detail below, LUT 318 provides information regarding transitional states. More particularly, LUT 318 may accept as input an old pixel state, a new pixel state and a transition count, and output a representation of an appropriate signal for the next transitional state (or for a final state). In short, LUT 318 stores waveform information.

Waveforms may be temperature dependent. Accordingly, LUT 318 may store complete waveform data corresponding to a plurality of different temperatures. Thus, some embodiments store complete waveform data corresponding to eleven different temperatures. Temperatures accounted for may range from, e.g, 125° C. through −55° C. To sense temperature, an external temperature sensor may be used. An exemplary temperature sensor is LM75 available from National Semiconductor. The temperature data may be represented in nine bits, two's complement format, with a least significant bit equal to 0.5° C. Note that EPD controller block 300 accounts for temperature-dependent EPD display requirements in a manner that is completely transparent to the host central processing unit. That is, the host central processing unit need only supply image data (e.g., in the form of data on a system data bus) to EPD controller block 300 for the corresponding image to be successfully displayed on an EPD. The host central processing unit is not required to separately monitor and account for temperature-dependent EPD requirements.

EPD controller block 300 also includes a memory 332, which may be shared by the host central processing unit and the EPD controller block 300. By way of non-limiting example, memory 332 is linked to data bus 304 that operates as a system data bus via double data rate (“DDR”) controller 302. Memory 332 includes three memory sections for storing old, new and current (i.e., transitional) pixel states. The old pixel state portion of memory 332 stores the states of an existing frame or a frame that is in the midst of being transitioned to a new frame. Memory 332 also includes a new pixel state portion. The new pixel state portion stores the states of a frame to which the EPD is transitioning. As discussed in detail below, a portion of memory 332 stores current pixel states, which represent transitional states between the old pixel states and the new pixel states.

Current pixel state data are stored in a frame buffer portion of memory 332. Frame buffer portion of memory 332 is visible to the host central processing unit. The current pixel state data stored in frame buffer portion of memory 332 are intended to represent actual pixel states, including intermediate or transitional steps between frames. That is, the current pixel states may correspond to portions of a waveform between new and old pixel states. Memory 332 also includes a step counter portion for tracking which step of a multi-step frame transition is being processed. Memory 332 further includes a step counter portion for tracking each step of a multi-step pixel transition for each pixel. Accordingly, each pixel may be independently updated. In some embodiments, there are up to 256 steps between any two frames; in such embodiments, the step counter portion of memory 332 may be eight bits long so that up to 256 steps may be tracked. It should be noted that other amounts of steps greater or equal to 256 steps may be used.

EPD controller block 300 also includes a pixel finite state machine (“FSM”) 314 operatively coupled to data bus 304 via three buffers (e.g., first-in/first-out (“FIFO”)) buffers 308, 310, 312). In particular, current pixel read FIFO1 buffer 308 is coupled to data bus 304 via data bus master 306, from which it receives current pixel data. An output of current pixel read FIFO1 buffer 308 is coupled to an input of pixel FSM 314, which receives current pixel data. New/old pixel and step read FIFO2 buffer 310 is coupled to data bus 304 via data bus master 306, from which it receives new and old pixel and step count data. New/old pixel and step read FIFO2 buffer 310 is also coupled to pixel FSM 314, to which it sends new and old pixel and step count data. New/old pixel and step write FIFO3 312 is coupled to pixel FSM 314, from which it receives new and old pixel and step count data. New/old pixel and step write FIFO3 312 is also coupled to data bus 304 via data bus master 306, to which it sends such data. An output of pixel FSM 314 is coupled to one input of multiplexer 316. Another input of multiplexer 316 is coupled to LUT interface 326. LUT interface 326 is bi-directionally coupled to data bus 322 that is configured to transmit data between the EPD controller block 300 and one or more EPD controller registers 328 accessible by the EPD controller block 300, which are also coupled to control logic 330. Control logic 330 may be configured to perform one or more hardware operations. For example, control logic 330 may include hardware configured to set one or more modes, set one or more clocks, enable one or more features (e.g., the auto stop feature), disable one or more features, and perform any other hardware operations. Data bus 322 may also be configured to transmit LUT update data to the LUT interface 326. LUT update data may include data that is used to update the data of one or more entries of an LUT (e.g., LUT 318). LUT interface 326 is also coupled to LUT 318. An output of multiplexer 316 is coupled to LUT 318. An output of LUT 318 is coupled to shift register 320, which is coupled to a EPD.

In some embodiments, pixel FSM 314 keeps track of line numbers. At the beginning of the frame (i.e., at the beginning of the first line), pixel FSM 314 may generate a frame synchronization signal; at beginning of each line, it may generate a line synchronization signal. In some embodiments, the EPD has 1200 lines, with each line including 1600 pixels. The frame synchronization and line synchronization signals may be used by LUT 318.

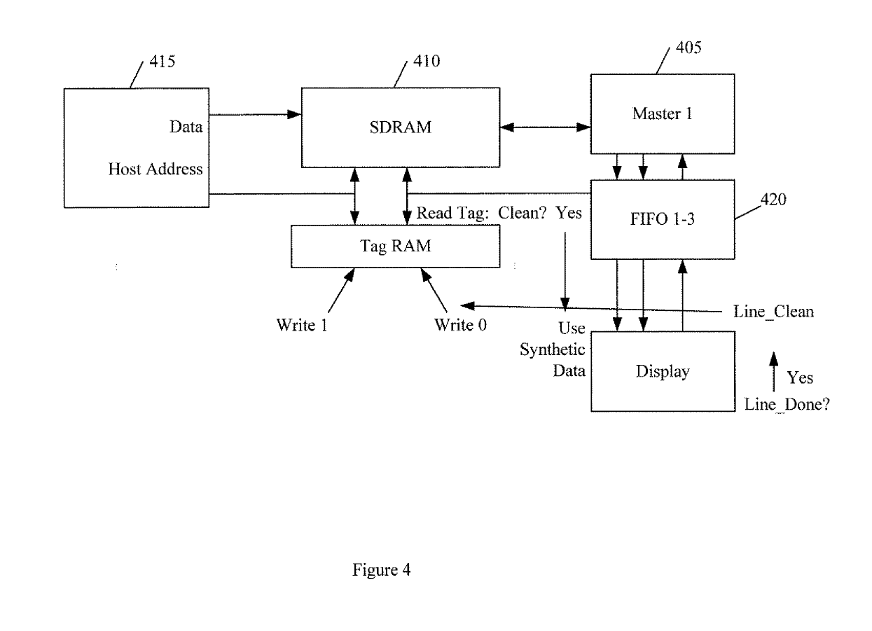

FIG. 4 is a schematic diagram that illustrates frame buffer caching according to an embodiment of the present invention. In general, caching the contents of the frame buffer (e.g., the frame buffer portion of memory 102 of FIG. 1) provide several advantages. For example, frame buffer caching feature can significantly reduce memory (e.g. DRAM 204 of FIG. 2) bandwidth requirements, particularly when only a partial image is updated by the host. Because the EPD is non-volatile, it can be treated as an image write-only memory. The frame buffer (i.e., current pixel memory portion) may be treated as a cache. More particularly, the frame buffer may be divided up into many “lines,” where a line is defined to be “clean” if all the pixels in the line have completed their update in the EPD panel, and a line is “dirty” if the host central processing unit writes one or more new current pixels into the line. In some embodiments, all cache tags are initialized to dirty. During display update scanning, the frame buffer caching feature may allow the clean lines to be skipped, reducing the number of memory (e.g., SDRAM) transactions. A control bit may be used to turn on or off the frame buffer caching feature.

Referring to FIG. 4, master 1 (405) maintains a set of cache tags, with one bit per cache line. These tags may be stored in memory (e.g., Tag RAM 410 or SDRAM 410) either on or off of the main EPD controller system. For each tag, a value of Tag=0 may indicate that the corresponding cache line is clean; a value of Tag=1 may indicate that the corresponding cache line is dirty.

In the process of scanning the frame buffer present in memory 410, master 1 (405) checks the state of the cache tag for the line to be retrieved. For a dirty cache line, the display operation may behave as if there were no frame buffer caching. If a cache line is clean, on the other hand, the read transfer of SDRAM 410 is skipped, as described above. In this case, master 1 (405) asserts a skip signal, and the EPD controller block feeds placeholder data into the display pipeline (e.g., FIFO 1-3 420). Such placeholder data may consist of equal old and new pixel pairs, with step counters set to zero (i.e., “end”). Such placeholder data will cause no change in the EPD display. If host 415 only updates a small region of the image, then the frame buffer caching feature reduces the number of SDRAM burst reads, as the clean lines can be skipped, and significant power saving can be achieved. Accordingly, the caching feature can significantly reduce memory 410 bandwidth requirements when only a portion of a frame is updated by reducing the amount of memory accesses.

An EPD controller block according to certain embodiments of the present invention may have four different modes of changing content displayed on an EPD. Each mode provides a different technique for changing an image on an EPD. A first such mode is referred to herein as an “initialization mode.” The initialization mode serves to prepare the EPD to display images after returning from a power off state. The initialization mode may operate by performing any, or a combination, of the following steps. The initialization mode may load initialization waveforms into LUT 318. The initialization mode may also load current pixel data into the frame buffer portion of memory 332 such that the initialization waveforms are triggered to display. Further, the initialization mode may write zeroes (0) to the frame buffer portion of memory 332, the old pixel data, the new pixel data, and one or more step counters.

A second mode is referred to herein as a “monochrome mode.” The monochrome mode operates such that pixels may be in only one of two states (e.g., black or white). Monochrome mode may utilize a bit pixel depth of a single bit per pixel (e.g., set to zero for black and one for white). In monochrome mode, mono-update waveforms may be used. In some embodiments, mono-update waveforms only include black-to-white and white-to-black transitions, with contiguous positive or negative pulses. In this case, the waveform can be consolidated into fewer steps with a standard or slower source driver clock. Monochrome mode can significantly reduce panel power consumptions.

Images displayed in monochrome mode may generally change faster than in grayscale modes. Accordingly, monochrome mode may be used to display video on an EPD. That is, monochrome mode is sufficiently agile to allow for displaying full-screen or partial-screen video images without noticeable lag. Alternately, or in addition, monochrome mode may be used to display cursors, typed or otherwise selected text, and pointers. More particularly, monochrome mode may be used to display a mouse or touch screen pointer, such as an arrow displayed on an EPD. Because features mentioned in this paragraph may change relatively rapidly, the agility provided by monochrome mode can accommodate their display on an EPD.

The third mode is referred to herein as “grayscale mode.” Grayscale mode operates to display images that may incorporate a plurality of shades of gray (e.g., 3, 4, 8, 16, 32, 64, 128 or 256 such shades, including black and white). Grayscale mode may utilize a bit pixel depth of three bits per pixel, four bits per pixel, or any other pixel depth.

The fourth mode is referred to herein as “grayscale clearing mode.” Grayscale clearing mode operates by first performing an initialization mode and then following it with a grayscale mode. Thus, grayscale clearing mode first clears any image present on the EPD and then displays a subsequent image in grayscale mode. Although four modes are discussed herein, such modes are exemplary only; other modes are possible and contemplated as being used with embodiments of the present invention.

As previously mentioned, the EPD controller block may enable the bit pixel depth to be programmed. Accordingly, the EPD controller block may support bit pixel depths of multiple bit sizes, such as one bit per pixel, three bits per pixel, four bits per pixel, or any other bit size that may be processed by the EPD controller block. The bit pixel depth may be programmed based on one or more factors such as, the need for power resources. In one embodiment, the use of a lower bit pixel depth (e.g., one bit per pixel) decrease the amount of power consumed by the EPD controller block. Conversely, the use of a higher bit pixel depth (e.g., four bits per pixel) may increase the amount of power consumed by the EPD controller block.

The modes (monochrome, grayscale and grayscale clearing) may be performed using a partial update (discussed presently) or a parallel update (discussed below in reference to FIG. 4). In general, after completion of one frame update, all the new and current pixels are the same, and all step counters are reset to zero. For a partial update, in the next scanning loop, if the current pixels are changed and the step count is not zero, these pixels start to update while the rest of the screen is unchanged. That is, a partial update updates only the pixels that have changed. For example, after previous update is done, when scanning to the middle of a frame, the current pixel may be different from the new pixel. In such instances, a partial update may cause this pixel to begin an update procedure without waiting for the process to loop back to the beginning of the frame.

In general, for each mode, when all the waveforms reach the end, and all the current and new pixels are equal, the frame update has completed. At this point, the EPD controller block may set a register bit that indicates a frame update has completed to a logical 1, and the EPD may stop running to save power.

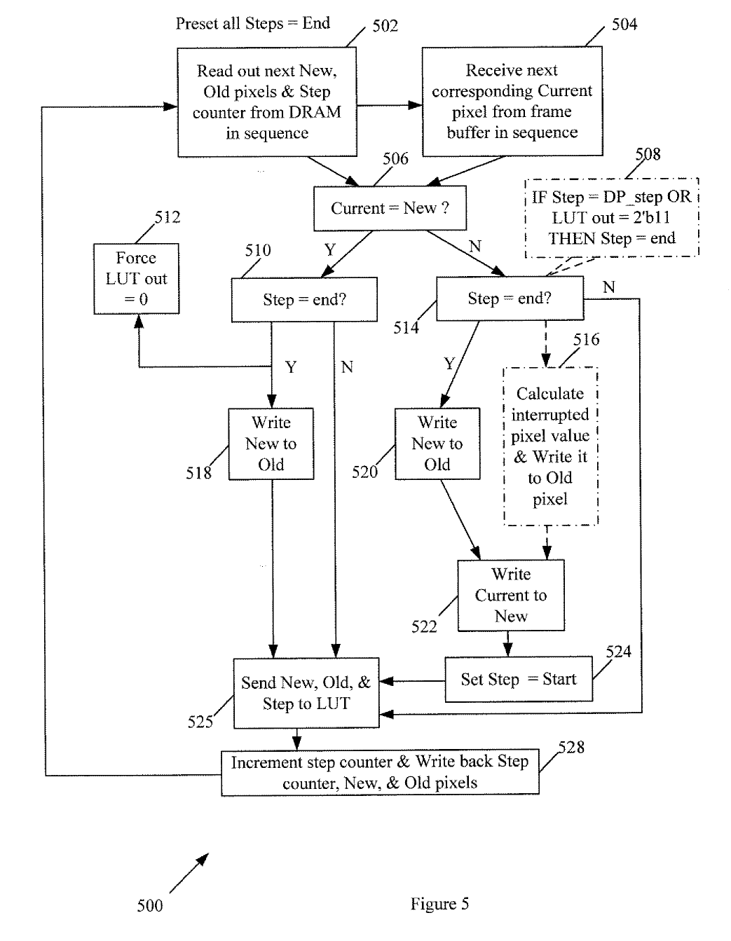

FIG. 5 is a flow chart illustrating a parallel pixel update according to an embodiment of the present invention. For a parallel update, each pixel has its own step counter to track its update process. When a pixel value is changed in the frame buffer, that pixel will update right away without waiting for others. In general, the parallel update process continues by sending new pixel data, old pixel data and step counter information to the LUT, which produced output data for the EPD, until the waveform reaches its end. If a current pixel differs from the corresponding new pixel (i.e., the pixel value has changed), then the pixel FSM will take actions to process it.

The process starts at block 502 by reading out the next values of new pixel, old pixel and step counter, e.g., from memory 332. At block 504, the next value for the current pixel is read, e.g., from frame buffer portion of memory 332. At block 506, the current pixel value is compared to the new pixel value. If the current pixel is the same as the new pixel (i.e., no change), the process branches to block 510, where the associated step counter is polled to determine whether the waveform is at an end. If the waveform is at an end (i.e., all transitional states of the pixel have been processed), the process branches to block 512, in which the LUT is forced to produce a designated end value (e.g., 0) when polled. After block 512, at block 518, the new pixel information is written to the old pixel portion of memory, and the process proceeds to block 526. If, at block 510, the step counter for the pixel indicates that the waveform is in progress, the process proceeds directly to block 526. At block 526, the old pixel value, the new pixel value and the step counter value are transmitted to the LUT, where output data for the EPD is retrieved.

Returning to block 506, if the current pixel value is not equal to the new pixel value, the process branches to block 514, at which the pixel step counter is polled to determine whether the waveform for that pixel is at an end. If so, then the process branches to block 520, at which the new pixel information is written to the old pixel portion of memory, and the process proceeds to block 522, where the current pixel is written to the new pixel memory. After block 522, the process proceeds to block 524, where the step counter is reset to zero, and then to block 426. If the waveform is not at an end, the process branches from block 514 to block 526, at which output data for the EPD is retrieved from the LUT.

After block 526, the process proceeds to block 528, at which the step counter for the pixel is incremented, and the new and old pixel data is updated in memory. The process then returns to block 502, completing one iteration of the parallel update procedure for one pixel.

Note that, in general, the LUT indicates an output to an EPD when provided with an old pixel value, a new pixel value and a step count, which indicates a current transitional state of the associated waveform. If a pixel is in the midst of an update operation (i.e., the associated waveform has not yet been fully processed), a new waveform generally cannot be started unless a starting old pixel value is provided to the LUT. However, intermediate pixel values may be difficult to ascertain, as in some embodiments a pixel's value cannot be determined by polling the EPD itself. Therefore, certain embodiments of the present invention provide a waveform interruption feature, which allows a new waveform to begin prior to an existing waveform's end. That is, a waveform interrupt feature may be used to begin a new waveform prior to an existing waveform's completion. In order to do so, the waveform interrupt feature estimates an intermediate pixel value based on the old pixel value, the new pixel value and the current step count (all previously provided to the LUT). The waveform interrupt feature estimates the current pixel value, and supplies this value as the old pixel value in order to begin a new waveform. That is, the waveform interrupt feature may proceed by supplying the LUT with an old pixel value, which is an estimate, a new pixel value, which represents the new target pixel, and a step count, which may be zero (a zero value may signify that a new waveform is to begin).

Returning now to FIG. 5, at block 514, embodiments that implement a waveform interrupt feature may proceed to block 516 instead of block 526 in the event that the current waveform has not finished. That is, certain embodiments may implement a waveform interrupt feature if the current pixel value is not equal to a new pixel value (as determined at block 506) and if the step counter is not at an end (as determined at block 514). At block 516, the current pixel value is estimated based on the old pixel value, new pixel value and step count, and the estimated value is written to the old pixel memory. The process then proceeds to block 522.

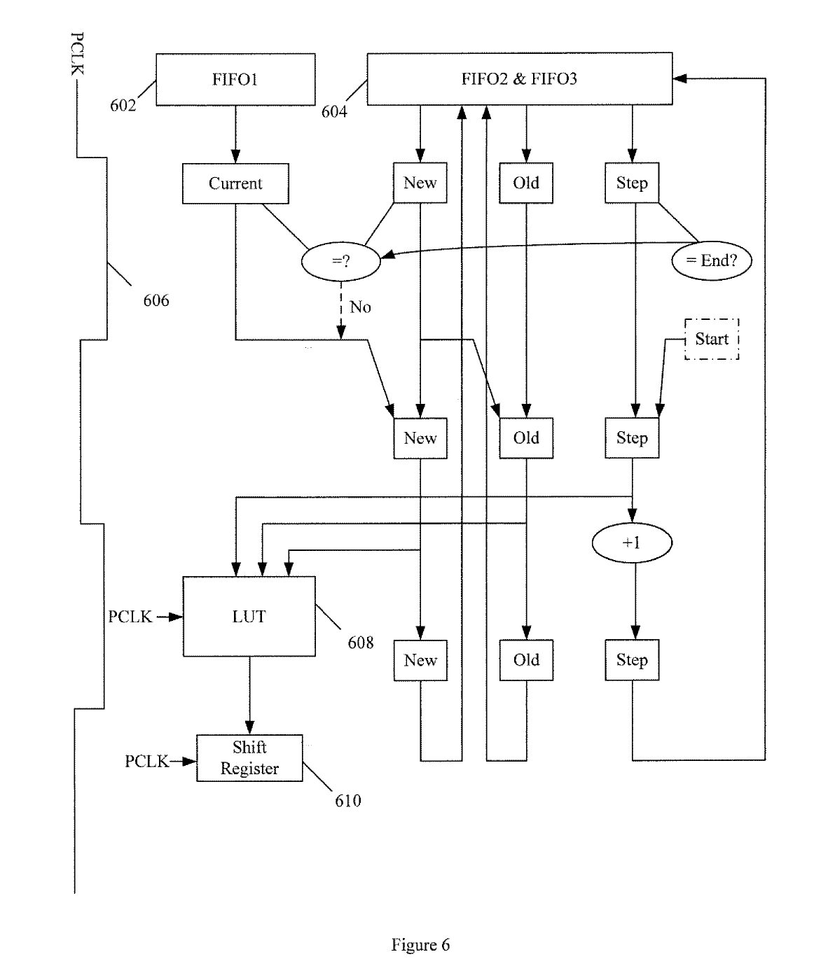

FIG. 6 is a pixel pipeline diagram illustrating a parallel pixel update according to an embodiment of the present invention. In particular, FIG. 6 depicts a parallel pixel update with reference to internal components of an EPD controller block such as that depicted in FIG. 3. FIFO1 602 may correspond to current pixel read FIFO1 buffer 308 of FIG. 3, FIFO2and FIFO3 604 may correspond to 310 and 312, LUT 608 may correspond to LUT 318, and shift register 610 may correspond to shift register 320. A pixel clock signal is depicted at 606. With each pixel clock tick, two pixels are read from FIFO1 602. Also, with each pixel clock tick, two new pixels, two old pixels and two pixel counters are read from FIFO2 and FIFO3 604. Thus, with each pixel clock tick, two pixels are processed. (Note that other embodiments, which process different numbers of pixels with each clock pulse are also contemplated.) If the current pixel and the new pixel are the same, and it is not the end of a update sequence, then this old-new pixel pair and step counter value are sent to the LUT to generate source driver data for the current step. The step counter is incremented after each step. If the update sequence reaches the end, then the new pixel is copied to the old pixel, which causes the LUT to output a zero. If the current pixel and the new pixel are different, it means the current pixel got changed. In this instance, if not during an update sequence (i.e., if at the start of an update sequence), then the process copies the new pixel data to the old pixel memory, copies the current pixel data to the new pixel memory, and starts a new update sequence for this pixel. If the current pixel and the new pixel are different, and it is during an update sequence, then the process increments the step counter by one, and continues the updating sequence. Optionally, a waveform interrupt feature may be implemented, which estimates the changing pixel value, starts a new update sequence from that value, and resets the pixel step counter to zero. Note that in both cases, the new, old, and step counter data are sent to the LUT to generate output data. The updated new and old pixel values, and the step counter values may be written back into the SDRAM after each pixel is processed.

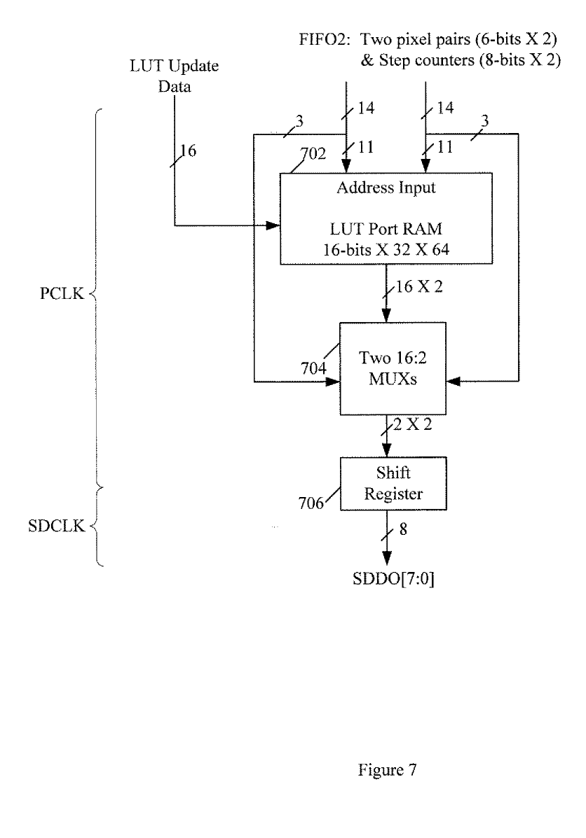

FIG. 7 is a schematic diagram of a LUT 702 and a shift register 706 according to an embodiment of the present invention. As previously described, EPD controller block includes a LUT 702. LUT 702 may a memory device, such as a random access memory (“RAM”). LUT 702 provides information regarding transitional states. More particularly, LUT 702 may accept as memory address input two pairs of old pixel data, a new pixel data and a transition count (e.g., step counter data), and output a representation of an appropriate signal for the next transitional state (or for a final state).

In one embodiment, the output (e.g., waveforms) of the LUT 702 may be temperature dependent. Accordingly, LUT 702 may store complete waveform data corresponding to a plurality of different temperatures. For each frame, an LUT may be loaded into a memory device, such as LUT dual port RAM. Each LUT may include up to 256 LUT step tables (or any other amount of step tables) that indicate the representation of an appropriate signal at particular steps. Accordingly, the received step counter data points to which LUT step to access.

If, for example, a bit pixel depth is programmed to be three bits per pixel, the least significant bits of the new and old pixels may be ignored and LUT 702 may receive memory address input for two pairs of new and old pixels that are three bits per pixel. Accordingly, the EPD panel may be configured to support eight levels of grayscale. Thus, the six bit (e.g., 3 bits per pixel of new pixel data +3 bits per pixel of old pixel data) memory address input may select the proper entry of the LUT step table, each LUT step table including up to 64 entries. Based on the memory address input, the LUT 702 may output a two-bit representation of the appropriate signal at a particular step via two multiplexers 704 for each pixel pair to the shift register 606. Subsequently, the shift register 706 may output the data to one or more source drivers as source driver data.

Embodiments of the present invention may include further power management features. Since EPD are persistent, once a frame is updated, it need not be continuously refreshed. Therefore, some embodiments limit or stop power consumption by the EPD itself once a frame update completes. This may be accomplished as follows. Completion of a frame update generally involves completing all steps of all associated waveforms (e.g., a separate waveform for each pixel that has changed). When all such waveforms complete their respective steps, all current pixels should equal all new pixels, as such pixels are reflected in memory. At this point, the frame update is complete. Accordingly, the EPD controller block may set an update bit (e.g., Update_Done=1) to signal that the update is complete. At that point, all power to the EPD may be suspended, e.g., by the EPD controller block. Upon the host central processing unit updating current pixels in the frame buffer, at least one line will become dirty, and the EPD controller block may resume full power operation and begin updating the frame. In addition, if the host central processing unit changes a pointer address stored in a frame buffer register (e.g., FB_base register), the EPD controller block may detect this change and resume full power operation to begin updating the frame (entering a display active-on mode).

The EPD controller block may enter any of a variety of low-power or no-power modes upon completion of a frame update (e.g., a standby-on mode, a sleep mode). As one example, the EPD controller block may initiate an auto-stop sequence that halts access to memory (e.g., memory 332 of FIG. 3) by stopping memory fetch sequences to the memory. The auto-stop sequence may be initiated if all new pixels stored in the memory match the current pixels and the step counters indicate the end of an update sequence. Accordingly, the auto-stop sequence may then halt the EPD controller block from performing memory fetch sequences.

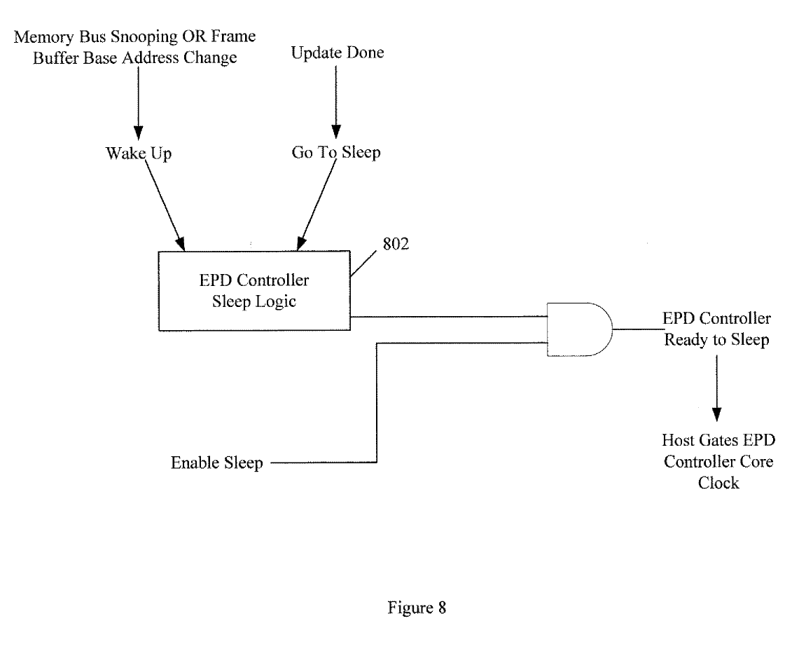

As another example, the EPD controller block may halt the EPD from operating in a standby-on mode. One a frame update sequence is complete, a standby bit (e.g., STDBY bit) may be set and the EPD controller block may enter the standby-on mode. In the standby-on mode, the EPD stops operating and update sequences have ended. In one embodiment, the EPD controller block may automatically enter the standby-on mode if an update sequence ends and an automatic stop bit is set (e.g., disp_auto_stop). Upon the host central processing unit updating current pixels in the frame buffer, at least one line will become dirty, and the EPD controller block may resume full power operation and begin updating the frame in the display active-on mode. Additional examples of power saving modes are illustrated in FIG. 8.

FIG. 8 is a logic diagram of sleep mode request logic 802 according to an embodiment of the present invention. The host central processing unit may control when the EPD controller block enters sleep mode. In sleep mode, the core clock signal of the EPD controller block (e.g., Core_Clk) and the clock of the pixel data bus (e.g., AXI_Clk) may be suspended for maximum power saving. Once the EPD controller block completes a frame update sequence (e.g., Update_done=1), the host central processing unit may place the EPD controller block in the sleep mode by asserting a sleep enable bit (e.g., Sleep_en). Accordingly, a ready-to-sleep signal may be asserted to inform the host central processing unit to suspend the core clock signal of the EPD controller block and the clock of the pixel data bus (e.g., data bus 304 of FIG. 3).

Upon the host central processing unit updating current pixels in the frame buffer, at least one line will become dirty, and the EPD controller block may resume full power operation and begin updating the frame. In addition, if the host central processing unit changes a pointer address stored in a frame buffer register (e.g., FB_base register), the EPD controller block may detect this change and resume full power operation to begin updating the frame (entering a display active-on mode).

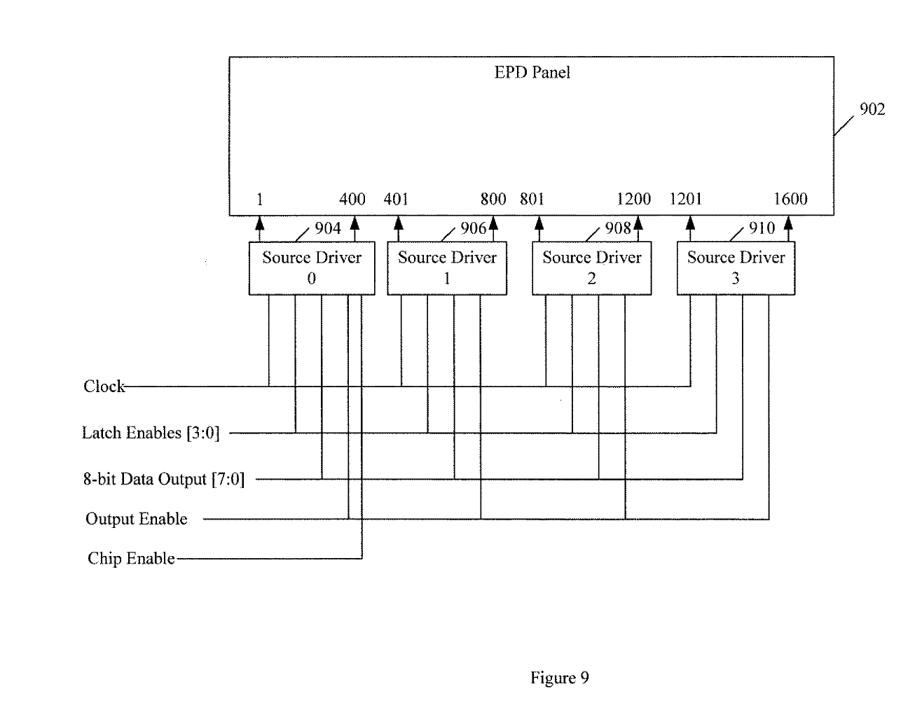

It should be noted that sleep mode may be initiated and terminated by either hardware or software. If, for example, a function clock gate control signal is set to a high value (e.g., function clock gate control=1), software may control the core clock of the EPD controller block and the clock of the pixel data bus using one or more software control signals (as described above with reference to FIG. 9). If, for example, a function clock gate control signal is set to a low value (e.g., function clock gate control=0), hardware may control the core clock of the EPD controller block and the clock of the pixel data bus using one or more hardware control signals.

FIG. 9 is a schematic diagram illustrating source driver connections according to an embodiment of the present invention. EPD 902 may be communicatively coupled to multiple source drivers 904, 906, 908, 910 as illustrated in FIG. 9. As previously discussed, source drivers 904, 906, 908, 910 may be configured to provide source driver data (e.g., a series of voltage potentials) to the particular row of display elements selected by a gate driver via one or more column electrodes and one or more TFTs of EPD 902 based on one or more input signals from the EPD controller block. EPD 902 may include 1600 pixels that are communicatively coupled to 1600 column electrodes.

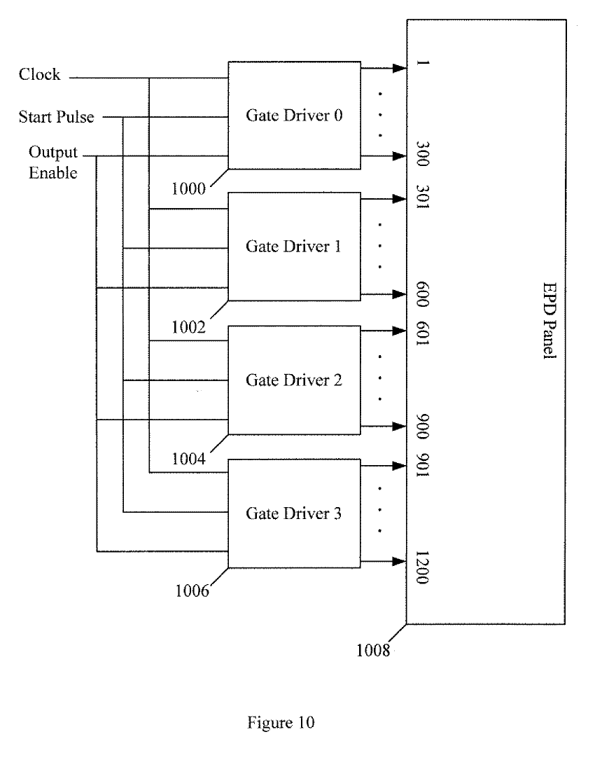

FIG. 10 is a schematic diagram illustrating gate driver connections according to an embodiment of the present invention. EPD 1008 may be communicatively coupled to multiple gate drivers 1000, 1002, 1004, 1006 as illustrated in FIG. 10. As previously discussed, gate drivers 1000, 1002, 1004, 1006 may be configured to provide gate driver data to EPD 1008 that selects a particular row of display elements to receive source driver data from the source drivers 904, 906, 908, 910 (illustrated in FIG. 9) based on one or more input signals from the EPD controller block. EPD 1008 may include 1200 rows of row electrodes that are communicatively coupled to the gates of multiple TFTs that are arranged in a row.

Certain embodiments allow host central processing units to provide image data (e.g., in the form of data on a system data bus) to an EPD controller block, which accounts for the specific needs of EPD. In such embodiments, the EPD provides a series of output signals to the EPD to effectuate the display of the corresponding image. Such embodiments allow a host to provide image data to an EPD in essentially the same manner as it would provide image data to a CRT or LCD display. As one example, certain embodiments translate image data to appropriate waveforms, which effectuate displaying the corresponding image on an EPD. As another example, certain embodiments account for temperature-dependent EPD requirements in a manner that is completely transparent to the host. As another example, certain embodiments may allow for use of different waveforms so that trade-offs are made between speed to update a frame and resultant image fidelity.

Other embodiments, uses, and advantages of the present invention will be apparent to those skilled in the art from consideration of the specification and practice of the present invention disclosed herein. The specification and drawings should be considered exemplary only, and the scope of the present invention is accordingly intended to be limited only by the following claims and equivalents thereof.

We claim:

1. A hardware implemented method for partially updating an electrophoretic display using an electrophoretic display controller block and a central processing unit that are integrated into a system on a chip, the method comprising:
scanning a complete set of new pixel values in an electronic memory;
comparing, during the scanning and using logical circuitry, the new pixel values to existing pixel values;
determining, during the scanning and based on the comparing, a set of pixels whose values have changed; and
initiating an update sequence for each pixel in the set of pixels whose values have changed, wherein the initiating occurs during the scanning, and wherein at least one update sequence comprises delivering a series of voltage potentials to a portion of the electrophoretic display corresponding to a changed pixel.

2. The method of claim 1 further comprising, prior to the scanning, delivering a second series of voltage potentials to each pixel in the electrophoretic display, wherein each pixel is cycled through black and white states at least once, whereby each pixel is set to a same state.

3. The method of claim 1 or 2, wherein the first series of voltage potentials comprises a grayscale transition.

4. The method of claim 1, wherein the first series of voltage potentials consists of black to white and white to black transitions.

5. The method of claim 1, wherein the central processing unit comprises a host central processing unit.

6. The method of claim 5, wherein the electronic memory comprises memory space that is shared with the host central processing unit.

7. The method of claim 1, wherein each new pixel value and each existing pixel value is associated with a programmable pixel bit depth.

8. The method of claim 7, wherein the pixel bit depth is programmed to be one of a group consisting of: (1) one bit per pixel; (2) three bits per pixel; and (3) four bits per pixel.

9. A hardware implemented method for updating an electrophoretic display in parallel using an electrophoretic display controller block and a central processing unit that are integrated into a system on a chip, the method comprising:
providing an electronic memory storing a current pixel value for each pixel in the electrophoretic display;
providing an electronic memory storing a new pixel value for each pixel in the electrophoretic display;
providing a hardware implemented step counter for each pixel in the electrophoretic display;
identifying a changed pixel, wherein a current pixel value for the changed pixel is different from a new pixel value for the changed pixel;
determining, for the changed pixel, whether a step counter associated with the changed pixel indicates that the pixel is transitioning to a new pixel value;
retrieving from an electronic memory a signal value associated with the current pixel value for the changed pixel, the new pixel value for the changed pixel and a step counter value for the changed pixel;
providing the signal value to a portion of the electrophoretic display corresponding to the changed pixel; and
updating the step counter value associated with the changed pixel.

10. The method of claim 9 further comprising, prior to the identifying, delivering a series of voltage potentials to each pixel in the electrophoretic display, wherein each pixel is cycled through black and white states at least once, whereby each pixel is set to a same state.

11. The method of claim 9 or 10, wherein the signal value corresponds to a shade of gray.

12. The method of claim 9, wherein the signal value corresponds to either black or white.

13. The method of claim 9, further comprising repeating, substantially in parallel and for a plurality of pixels, the steps of identifying, determining, retrieving, providing the signal value and updating.

14. The method of claim 9, wherein the central processing unit comprises a host central processing unit.

15. The method of claim 14, wherein the electronic memory comprises memory space that is shared with the host central processing unit.

16. The method of claim 1, wherein each new pixel value and each current pixel value is associated with a programmable pixel bit depth.

17. The method of claim 16, wherein the pixel bit depth is programmed to be one of a group consisting of: (1) one bit per pixel; (2) three bits per pixel; and (3) four bits per pixel.

18. A system for controlling an electrophoretic display using an electrophoretic display controller block and a central processing unit that are integrated into a system on a chip, the system comprising:
a computing apparatus configured to store an existing frame, wherein the existing frame comprises a plurality of existing lines, wherein each existing line comprises a set of existing pixel values;
a computing apparatus configured to receive a new frame and store the new frame in an electronic memory, wherein the new frame comprises a plurality of new lines, wherein each new line comprises a set of new pixel values;
a computing apparatus configured to compare each existing pixel value to a corresponding new pixel value to determine a set of pixels whose values have changed; and
a computing apparatus configured to deliver a series of voltage potentials to a portion of the electrophoretic display corresponding to a changed pixel.

19. The system of claim 18, wherein a computing apparatus is configured to treat each new line associated with unchanged pixel values as a clean line.

20. The system of claim 10, wherein a computing apparatus is configured to treat each new line associated with at least one changed pixel as a dirty line.

21. The system of claim 20, wherein a computing apparatus is configured to scan each dirty line.

22. The system of claim 18, wherein the central processing unit comprises a host central processing unit.

23. The system of claim 22, wherein the electronic memory comprises memory space that is shared with the host central processing unit.

24. The system of claim 18, wherein each existing pixel value and each new pixel value is associated with a programmable pixel bit depth.

25. The system of claim 24, wherein the pixel bit depth is programmed to be one of a group consisting of: (1) one bit per pixel; (2) three bits per pixel; and (3) four bits per pixel.

26. The system of claim 25, further comprising a computing apparatus configured to manage a flow of power to the electrophoretic display.

27. The system of claim 26, wherein the computing apparatus is configured to managed the flow of power to the electrophoretic display by operating in at least one of a display active-on mode, a standby-on mode, and a sleep mode.

28. The system of claim 27, wherein the sleep mode is initiated by one or more software control signals.

29. The system of claim 27, wherein the sleep mode is initiated by one or more hardware control signals.
